(19) United States
(12) Patent Application Publication
(10) Pub. No.: US 2025/0097308 A1
(43) Pub. Date: Mar. 20, 2025

(54) Peer-to-Peer Feedback and Trustworthiness Assessment in Online Social Platforms

(71) Applicant: Stephon Stehony, Groton, CT (US)

(72) Inventor: Stephon Stehony, Groton, CT (US)

(21) Appl. No.: 18/369,856

(22) Filed: Sep. 19, 2023

(51) Int. Cl. H04L 67/306; G06Q 50/00; H04L 9/40

(52) U.S. Cl. CPC H04L 67/306; G06Q 50/01; H04L 63/0861; H04L 2463/082

(57) ABSTRACT

The disclosed invention pertains to a novel social media platform facilitating community members to give feedback based on their interactions with fellow members. Specifically, it revolves around a system enabling users to offer feedback through an application or website, and subsequently view aggregated feedback about a particular user's interactions. Accessible via mobile and other computing devices, this software application and website empower community members to share real-time experiences and rate other users directly on their profiles.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention pertains to the domain of online feedback and review systems, encompassing various platforms such as apps and websites.

While the invention has a broad application in telecommunication services, it distinctly introduces an automated social feedback system. This system operates as a community service, empowering users to rate, review, provide testimonials, lodge complaints, or extend compliments about fellow users.

### Description of the Related Art

Historically, online platforms and computer systems have primarily focused on allowing users to produce and access content related to product reviews, service evaluations, or feedback about commercial entities. The concept of user-to-user reviews and ratings was largely uncharted territory.

One of the primary concerns in online interactions has been trust. Traditional platforms provided no mechanism for understanding the credibility, demeanor, or trustworthiness of individual users based on shared experiences or mutual interactions.

As online communities grew, so did the complexities of interpersonal interactions. Without a structured mechanism to capture feedback about individual user experiences, there was no easy way to gauge the quality or nature of interactions one might expect with any given user.

Despite the importance of social connections in the digital age, no platform provided tools for users to share insights about their interactions with others, leading to a lack of transparency and understanding in online communities.

Even within established social networks, understanding the opinions and experiences of peers regarding their interactions with other community members was nebulous at best.

The idea of aligning personal experiences with feedback from trusted peers, an essential feature for informed decision-making in any community, was notably absent from all major online platforms.

As online interactions diversified across platforms, the need for a centralized feedback mechanism became evident. Yet, no existing platform offered a comprehensive space to gather, share, or evaluate feedback about individual users.

Traditional feedback formats, which revolved around products or services, were not designed to capture the nuanced dynamics of interpersonal experiences, leaving a significant gap in understanding user-to-user interactions.

While some online communities facilitated interactions, there was no system in place to provide genuine, structured feedback on these interactions or to understand the broader implications of user behavior across the platform.

In summary, while the digital space teemed with user interactions and social connections, a structured and dedicated mechanism for understanding, evaluating, and sharing insights about user-to-user experiences was conspicuously missing. The stage was set for a groundbreaking system that could address these gaps and provide a holistic view of interpersonal interactions in the online space.

### SUMMARY

Existing online platforms allow users to share content, establish relationships, and exchange opinions. However, a void persists in these platforms as they lack a dedicated mechanism for users to provide feedback on their real-world interactions with other members. This gap inhibits genuine online reviews and ratings based on tangible experiences.

The present invention seeks to address these limitations by introducing a unique system wherein users can rate and review their peers based on real-world interactions. This shift towards experience-based feedback provides a novel approach to online user interactions distinct from existing models.

A hallmark of this invention is its rigorous profile confirmation process, emphasizing the platform's commitment to authenticity and minimizing fraudulent feedback. By ensuring a true representation of its users, the system curtails spurious feedback and increases trust among its members.

Recognizing the depth and variation in online relationships, the platform allows users to differentiate feedback based on the closeness of their relationship. This feature ensures a nuanced approach to online interactions, fostering meaningful exchanges.

To maintain the quality of feedback and a positive digital environment, the platform incorporates a clear code of ethics. Feedback that violates set rules can be flagged or removed, safeguarding user experience.

The robust backend infrastructure comprises a database server optimized for feedback management, storage, and retrieval. An intuitive GUI interface ensures a seamless user experience for both browsing and providing feedback.

A notable feature of the invention is the feedback visibility control. Users can dictate who accesses their feedback, choosing among options like “Family,” “Everyone,” and “Anonymous,” ensuring both flexibility and privacy.

In essence, this invention revolutionizes online interactions by placing genuine, real-world experience-based feedback at its core. It addresses existing gaps in the online community landscape, offering a more authentic and respectful digital environment.

This summary outlines the invention's distinct features and advantages, with a detailed description following that provides a comprehensive understanding of its embodiments.

### BRIEF DESCRIPTION OF DRAWING

non-limiting and non-exhaustive embodiments of the present invention are described with reference to the following drawings. The system and method of the present invention will now be described with reference to the accompanying flow chart drawing figure, in which:

FIG. 1 This illustration shows a functional diagram illustrating the embodiment of the online & IT based environment for use of the invention.

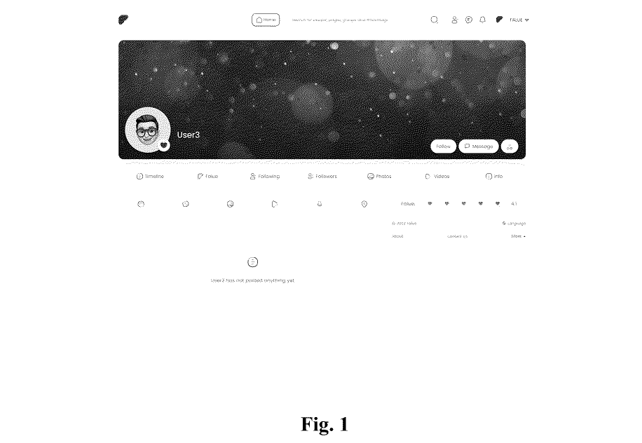

FIG. 2 This illustration depicts the rating and reviews system at the core of the invention. It visually represents the user interface and interactions that enable community members to provide ratings and reviews about their experiences with other users. The figure demonstrates the integration of quantitative rating scales and qualitative feedback features within the application.

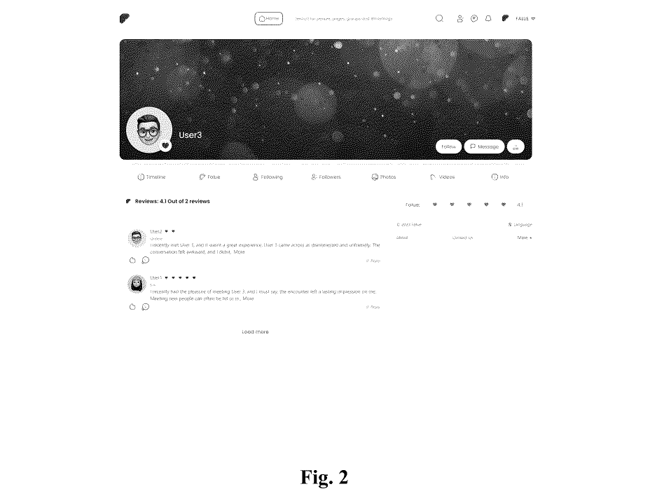

FIG. 3 This visual representation illustrates a privacy feature within the application, specifically the option to share a post exclusively with family members. It depicts the user interface where a user can select this privacy setting when creating or sharing a post. The figure demonstrates how users can choose to limit the visibility of their content to only those identified as “family” within their network, ensuring a more controlled and private sharing experience.

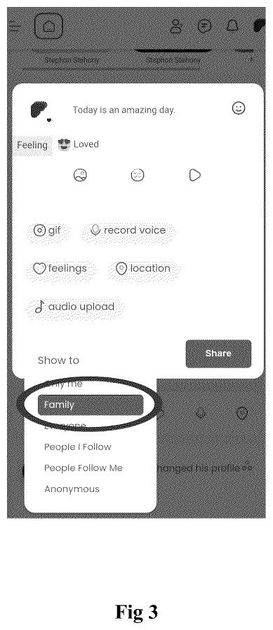

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The present invention will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete and will fully convey the scope of the invention to those skilled in the art. Among other things, the present invention may be embodied as methods or devices. Accordingly, the present invention may take the form of an entire hardware embodiment, an entire software embodiment, or an embodiment combining software and hardware aspects. The following detailed description is, therefore, not to be taken in a limiting sense.

Briefly stated, the present invention is directed toward online social media platforms and methods of implementing rating and feedback systems for users to rate other users. The system allows the user to register to the application through a simple registration process and then participate in the online social community. The invention further enables the user to rate the user and their experience on a numerical rating scale.

The invention is based on components of an exemplary environment in which the invention may be used. The online social media and rating system has focused components and is easy to use. Furthermore, the online web-based application allows users to rate other users by giving their opinion on a quantitative basis through a scale and also to express their ideas, suggestions, and feelings through a qualitative mode by narrating their experience. The user can rate the other user using a numerical rating scale. Additionally, the user can leave a short review about their interaction and experience with the other user.

The invention, which is an online community and rating/feedback system, can be accessed and used from a personal computer, laptop, PDA, or any computing device. To utilize the web-based application, the user needs to be connected to the internet. This can be through local area networks (LANs)/wide area networks (WANs), wireless networks, or independent internet sources. Further, the internet would connect the user to the online feedback application server through the user's computing or mobile device, where applicable.

Generally, the client device can include virtually any computing device capable of receiving and sending a message over a network, such as LAN/WAN, wireless network, and the like, to and from another computing device, such as a server or another mobile device. The set of devices can include those that connect using a wired communications medium like personal computers, multiprocessor systems, microprocessor-based or programmable consumer electronics, network PCs, etc. It can also include devices that typically connect using a wireless communications medium such as cell phones, smart phones, tablets, or PDAs. Moreover, client devices can be any device equipped to communicate over a wired or wireless communication medium.

The client device might include a browser application configured to receive and send web pages, web-based messages, etc. This browser can display graphics, text, multimedia, and other content using web-based languages like HTML.

Furthermore, client devices, especially smartphones, allow users to download the application. The online platform is responsive, ensuring the application functions seamlessly on mobile computing devices. This encompasses devices like cellular phones, smart phones, PDAs, handheld computers, tablet computers, and integrated devices that combine one or more of the preceding devices.

The online feedback application is available via a website and also as an app. Users can easily download the application from app stores. The invention's distinct feature is its ability to allow one user to rate another after their interaction on the social media platform.

In its further embodiments, the system offers a method for personalizing reviews for users on the platform after their interaction. This involves receiving a rating and a recommendation wherein the rating is a numerical value on a scale, and the recommendation is a binary endorsement. The process also entails a request from a user to view ratings and recommendations for one or more users, which are then displayed on the user interface.

The system also offers an option to post news feeds to family members only. It introduces a unique mechanism for presenting dynamically selected media content to users within a social network environment. The content is selected based on a user's relationships with others in their network. Hence, the content is personalized, making it uniquely relevant to the viewer.

This platform, being an open forum for ratings and reviews, operates under a strict code of ethics and privacy policy. Administrators have the right to remove feedback that violates these guidelines.

Preferred embodiments of the invention involve a user profile that includes details such as profile picture, profile ID, first and last names, linked social media accounts, lists of followers and following, and a family list.

The system also features user interaction components like a messaging system and group chat.

Content components in the system comprise a profile newsfeed, posting capability, and saved post sections.

There's a comprehensive rating and review system that offers features like a rating mechanism, an anonymous review option, review reply functionality, and a review privacy toggle.

Additionally, the system showcases user status and recognition, highlighting the top-rated users based on positive feedback.

Search and navigation components are also integrated, offering user search functionality and a trending post feature.

There's a stringent identity confirmation & verification process. The initial confirmation involves a series of steps to bolster the trust factor. Advanced verification processes require additional documentation, culminating in a ‘verified’ status for users.

An internal mechanism ensures all feedback complies with platform guidelines. There's also a flagging system where users can report inappropriate content.

The system also allows integration with other platforms, enriching user profiles.

The system's “Find Friends” feature is geolocation-based, enabling users to discover nearby users and potentially meet in real-world settings.

The system has a frontend for user interactions and a backend for server functions. All user data, reviews, ratings, and registrations are securely stored on the server.

After downloading the app and completing registration, users can set up their profiles. Profile setup entails inputting necessary personal details.

For authenticity, the system has various confirmation processes, including profile ID confirmation and detail verification.

Home feed allows users to view and engage with content, while the “Find Friend” feature introduces potential connections. The Rate & Review features let users rate others on a defined scale. Ratings have distinct color codes to indicate different ranges. Reviews can be made anonymously, and users can reply to the feedback on their profiles.

Users can also mark other users as ‘Family’, indicating a closer bond. Personal chats or group chats can be initiated, and users can send greetings to others.

News Feed enables users to post diverse content, while the Notifications system keeps them updated on platform interactions.

Modifications and additions can be made without diverging from the essence of the invention. This description is not exhaustive, and the invention's scope is defined by the claims and their equivalents.

The invention claimed is:

1. An online community-based social media platform with feedback, rating and review software application which is available through a web portal and any mobile computing device, accessible through an app; which can be downloaded and used at users' discretion for interaction and rating the other users, through a quantitative and qualitative method that is embedded in the application.
As per claim 1, the application presents a unique form of social media platform featuring a review, rating, and feedback system that empowers users to share their assessments of fellow users.
As per claim 1, the application is user-friendly accessibility, allowing users to connect via any computing device with internet access.
As per claim 1, the application operates as a web-based software platform hosted on a dedicated server with an integrated database designed for the secure storage and reporting of user reviews. It prioritizes user privacy through robust encryption and other protective software measures.
As per claim 1, the invention is a computer-implemented social media platform featuring a comprehensive feedback, review, and data processing system seamlessly integrated into a dedicated software application. This system encompasses essential components, including a database, server infrastructure, and a user-friendly interface tailored for community members. Additionally, a dedicated administrative team oversees operations to ensure the platform's adherence to established guidelines and privacy policies while promoting fair and transparent user reviews.

2: A method for confirming a user's identity in a mobile application through the establishment of a distinct Profile ID, separate from a user's changeable profile picture, the method comprising:
As per claim 2, a method of accessing a user profile within said mobile application;
As per claim 2, a method of prompting the user to input their first and last name in a designated field;
As per claim 2, a method of storing and establishing the input first and last name as the immutable default name on the user's profile, distinct from any other profile attributes;
As per claim 2, a method of prompting the user to upload a video recording of themselves stating their full name; with or without the accompaniment of a photo ID for further confirmation.
As per claim 2, a method of prompting the user to upload a dedicated image of themselves distinct from a changeable profile picture;
As per claim 2, a method of setting the uploaded dedicated image as the immutable Profile ID, uniquely placed within the user's profile, wherein said Profile ID acts as a primary visual identification of the user and remains unchanged through regular profile editing means;
As per claim 2, a method of barring user-initiated modifications to the default name and Profile ID through standard profile editing functions;
As per claim 2, a method of permitting modifications to the default name and Profile ID exclusively through a distinct update confirmation process inside the application.

3. A method within an online social media platform, wherein users are provided with the option to restrict the visibility of their posted content exclusively to individuals identified as “family” within their network, thereby enhancing user control over content sharing and privacy management.
As per claim 3, further comprising allowing users to define and manage their “family” list by selecting specific individuals from their network, thus providing users with flexibility in determining the recipients of their shared content.
As per claim 3, further comprising enabling users to set post visibility options on a per-post basis, providing granular control over which posts are shared with family members only and which are shared with a broader audience.

4. A method for assessing and representing users' trustworthiness, behavior, or reputation based on peer-to-peer interactions within a digital environment, said method comprising:
Authentication Process;
Review and rating Access;
Interaction Assessment Mechanism;
Anonymity and privacy Features;
Rating Visualization; and,
Aggregate scoring representation.
As per claim 4, the system involves mandating users to confirm their identity through a multi-step verification method;
As per claim 4, the system involves entering first and last name, which post-confirmation becomes a permanent and unmodifiable name on their profile;
As per claim 4, the system involves uploading a video of the user vocalizing their full name;
As per claim 4, the system involves submitting a distinct image, designated as an unchangeable Profile ID in their profile tab;
As per claim 4, the system involves the Review and Rating Access enables users to access the rating and review features on the platform;
As per claim 4, the system involves providing an intuitive interface for users to browse and visit another user's profile;
As per claim 4, the system involves interaction assessment mechanism wherein initiating an option for users allow to rate other users grounded on both digital interactions within the platform and real-world encounters;
As per claim 4, the system involves facilitates a segment for users to elucidate their experience or interactions, forming a review for the user being assessed;
As per claim 4, the system involves anonymity and Privacy Features;
As per claim 4, the system involves granting users the choice to remain unidentified when leaving feedback, ensuring their identity remains undisclosed to the reviewed user and the platform's broader user base;
As per claim 4, the system involves allowing users to opt for privacy settings where their received reviews are concealed, visible only to themselves;
As per claim 4, the system involves users to choose private settings for their reviews are inhibited from accessing other users' reviews;
As per claim 4, the system involves a rating visualization mechanism wherein numerical ratings are associated with a color-coded representation system, where different ranges of scores correspond to distinct colors for ease of interpretation;
As per claim 4, the system involves defining various ranges for numerical ratings, wherein each range corresponds to a specific color in the color-coded representation system, but not limited to any specific numbers or colors;
As per claim 4, the system involves an aggregate scoring and representation mechanism;
As per claim 4, the system involves tabulating individual numerical ratings in an aggregate manner to derive an overall score for each user;
As per claim 4, the system involves visually displaying the derived aggregate score for users.
